(19) United States
(12) Patent Application Publication
(10) Pub. No.: US 2022/0306859 A1
(43) Pub. Date: Sep. 29, 2022

(54) RESIN COMPOSITION, BONDING FILM, LAYERED BODY INCLUDING RESIN COMPOSITION LAYER, LAYERED BODY, AND ELECTROMAGNETIC WAVE SHIELDING FILM

(71) Applicant: TOAGOSEI CO., LTD., Minato-ku, Tokyo (JP)

(72) Inventors: Yuya OKIMURA, Nagoya-shi, Aichi (JP); Masahiro TORII, Nagoya-shi, Aichi (JP); Makoto HIRAKAWA, Nagoya-shi, Aichi (JP); Masashi YAMADA, Nagoya-shi, Aichi (JP)

(21) Appl. No.: 17/605,715

(22) PCT Filed: Apr. 15, 2020
(86) PCT No.: PCT/JP2020/016572

§ 371 Date: Oct. 22, 2021

(30) Foreign Application Priority Data
Apr. 26, 2019 (JP) 2019-085255

(51) Int. Cl. C08L 75/06; C08L 63/04; C08L 77/06; C08G 59/24

(52) U.S. Cl. CPC C08L 75/06; C08L 63/04; C08L 77/06; C08G 59/245; C08L 2201/08; C08L 2205/03; C08L 2203/16; C08L 2203/20

(57) ABSTRACT

Provided are: a resin composition, containing a polyester polyurethane resin (A), an epoxy resin (B), and a polyamide resin (C); as well as a bonding film, a layered body including a resin composition layer, a layered body, and an electromagnetic wave shielding film, each using the resin composition.

### TECHNICAL FIELD

The present invention relates to a polyester polyurethane-based resin composition as a material effective for producing a printed wiring board, particularly a flexible printed wiring board or a build-up method multi-layer printed wiring board, which is high in adhesive force to polyimide films or metals, a cured product of which has heat resistance and moist heat resistance, and which is excellent in liquid stability or processability. Further, the present invention relates to a bonding film in which the resin composition is bonded to a release film, a layered body including a resin composition layer in which the resin composition is bonded to a base film, a layered body including a layer that is obtained by curing the resin composition, and an electromagnetic wave shielding film that is bonded to a flexible printed wiring board or the like to be preferably used for shielding electromagnetic noise generated from an electric wiring.

### BACKGROUND ART

Since flexible printed wiring boards can be mounted three-dimensionally and at high density even in a limited space, applications thereof have been expanding. In recent years, along with miniaturization, weight reduction, and the like of electronic devices, related products of flexible printed wiring boards have been diversified, and the demand therefor has been increasing. As such related products, there are flexible copper-clad laminates in which copper foils are affixed to polyimide films, flexible printed wiring boards in which electronic wirings are formed on flexible copper-clad laminates, flexible printed wiring boards including reinforcing plates in which the flexible printed wiring boards and the reinforcing plates are affixed to each other, multilayer plates in which flexible copper-clad laminates or flexible printed wiring boards are layered and joined, and the like. For example, when manufacturing flexible copper-clad laminates, adhesives are usually used to cause polyimide films and copper foils to adhere to each other.

As conventional adhesive compositions or conventional layered bodies, the methods described in Patent Documents 1 to 3 are known.

Patent Document 1 describes a halogen-free flame retardant adhesive composition, characterized by containing a solvent-soluble polyamide resin (A) in a solid state at 25° C., a phenoxy resin (B), an epoxy resin (C) that does not contain a halogen atom, and a phosphorus-based flame retardant (D) that has a structure represented by the following general formula (1), in which the epoxy resin (C) is an epoxy resin that has three or more epoxy groups in one molecule, in which the content of the phenoxy resin (B) is from 100 to 450 parts by mass with respect to 100 parts by mass of the polyamide resin (A), in which the content of the epoxy resin (C) is from 1 to 60 parts by mass with respect to 100 parts by mass in total of the polyamide resin (A) and the phenoxy resin (B), and in which the content of the phosphorus-based flame retardant (D) is from 5 to 100 parts by mass with respect to 100 parts by mass in total of the polyamide resin (A) and the phenoxy resin (B).

Further, Patent Document 2 describes a layered body, characterized in that a curable resin composition is layered on at least one surface of a polyimide-based film, a polyester-based film, or a metal foil, in which the curable resin composition contains a polyester-based polymer (a) that contains two or more carboxyl groups in a molecule, that has a number average molecular weight of from 5,000 to 100,000, and that has a molecular weight per carboxyl group of from 1,500 to 10,000, an epoxy resin (b) that contains two or more epoxy groups in a molecule, and an epoxy resin curing promoter (c), in which the curable resin composition can retain thermoplasticity at 5° C. for a period of 5 months or longer. Patent Document 2 also describes a layered body, in which the curable resin composition of the above-described layered body has been cured to be layered on a metal foil (including a metal wiring).

Further, Patent Document 3 describes a resin composition for an adhesive, the composition containing a polyurethane resin (a) that contains a carboxyl group, that has an acid value (unit: equivalent/10⁶ g) of from 100 to 1,000, that has a number average molecular weight of from 5.0×10³ to 1.0×10⁵, and that has a glass transition temperature of from −10° C. to 70° C., an epoxy resin (b) that contains a nitrogen atom, and an epoxy resin (c) that has a dicyclopentadiene skeleton, in which a formulation ratio of the resin (b) is from 0.1% by mass to 20% by mass with respect to the whole epoxy resin contained in the resin composition.

Patent Document 1: Japanese Patent Publication No. 5846290

Patent Document 2: Japanese Patent Application Laid-Open No. 2005-125724

Patent Document 3: Japanese Patent Application Laid-Open No. 2010-84005

### SUMMARY OF INVENTION

### Technical Problem

An object to be solved by the present invention is to provide a resin composition that is excellent in conductivity even after a long-term (1,000 hours) storage under environment of high temperature and high humidity (85° C. 85% RH).

Another object to be solved by the present invention is to provide a bonding film, a layered body including a resin composition layer, a layered body, or an electromagnetic wave shielding film, each using the resin composition.

### Solution to Problem

Means for solving the problem described above include the following aspects.

<1> A resin composition, including: a polyester polyurethane resin (A); an epoxy resin (B); and a polyamide resin (C).

<2> The resin composition according to <1>, in which a content of the polyester polyurethane resin (A) is from 10% by mass to 70% by mass, and a content of the polyamide resin (C) is from 10% by mass to 70% by mass, each with respect to a total amount of the polyester polyurethane resin (A), the epoxy resin (B), the polyamide resin (C), and an imidazole silane compound (E) that may be included as an optional component in the resin composition.

<3> The resin composition according to <1>or <2>, further including an organic filler (D).

<4> The resin composition according to <3>, in which a content of the organic filler (D) is from 5 parts by mass to 40 parts by mass with respect to the total amount, of 100 parts by mass, of the polyester polyurethane resin (A), the epoxy resin (B), the polyamide resin (C), and the imidazole silane compound (E) that may be included as an optional component in the resin composition.

<5> The resin composition according to any one of <1> to <4>, further including the imidazole silane compound (E).

<6> The resin composition according to <5>, in which a content of the imidazole silane compound (E) is from 0.1% by mass to 10% by mass with respect to the total amount of the polyester polyurethane resin (A), the epoxy resin (B), the polyamide resin (C), and the imidazole silane compound (E) in the resin composition.

<7> The resin composition according to any one of <I>to <6>, in which the epoxy resin (B) includes at least one of a bisphenol A type epoxy resin or a novolak type epoxy resin.

<8> The resin composition according to any one of <1> to <7>, in which a number average molecular weight of the polyester polyurethane resin (A) is from 10,000 to 80,000, and a molecular weight per urethane bond in the polyester polyurethane resin (A) is 200 to 8,000.

<9> The resin composition according to any one of <1> to <8>, in which an acid value of the polyester polyurethane resin (A) is from 0.1 mgKOH/g to 20 mgKOH/g.

<10> The resin composition according to any one of <1> to <9>, in which a diol component configuring the polyester polyurethane resin (A) includes a diol having a side chain.

<11> The resin composition according to any one of <1> to <10>, in which the polyester polyurethane resin (A) includes a polyester polyurethane resin having a polyester structure that has a number average molecular weight of from 8,000 to 30,000.

<12> The resin composition according to any one of <1> to <11>, including, when a total amount of a diamine component configuring the polyamide resin (C) is 100 mol %, 20 mol % or more of piperazine as the diamine component.

<13> The resin composition according to any one of <1> to <12>, further including a metal filler (F).

<14> The resin composition according to <13>, in which a content of the metal filler (F) is from 10 parts by mass to 350 parts by mass with respect to the total amount of 100 parts by mass of the polyester polyurethane resin (A), the epoxy resin (B), the polyimide resin (C), and the imidazole silane compound (E) that may be included as an optional component in the resin composition.

<15> The resin composition according to <13> or <14>, in which the metal filler (F) is a conductive filler.

<16> A bonding film, including: a resin composition layer that consists of the resin composition according to any one of <1> to <15>; and a release film that is in contact with at least one surface of the resin composition layer, in which the resin composition layer is in a B-stage state.

<17> A layered body including a resin composition layer, the layered body including: a resin composition layer that consists of the resin composition according to any one of <1> to <15> and a base film that is in contact with at least one surface of the resin composition layer, in which the resin composition layer is in a B-stage state.

<18> A layered body, including a cured layer obtained by curing the resin composition according to any one of <1>to <15>.

<19> An electromagnetic wave shielding film, including a resin composition layer that consists of the resin composition according to any one of <1> to <15>.

### Advantageous Effects of Invention

According to the present invention, it is possible to provide a resin composition that is excellent in conductivity even after a long-term (1,000 hours) storage under environment of high temperature and high humidity (85° C., 85% RH).

Further, according to the present invention, it is possible to provide a bonding film, a layered body including a resin composition layer, a layered body, or an electromagnetic wave shielding film, each using the resin composition.

### DESCRIPTION OF EMBODIMENTS

The explanation of constituent elements described below may be made based on representative embodiments of the present invention, but the present invention is not limited to such embodiments. Herein, the range “(from) X to Y” is used to mean a range that includes the numerical values X and Y described before and after “to” as the lower limit value and the upper limit value, respectively.

In the numerical range described herein stepwise, the upper limit value or the lower limit value described in one numerical range may be replaced with the upper limit value or the lower limit value of another numerical range described stepwise. Further, in the numerical range described herein, the upper limit value or the lower limit value of the numerical range may be replaced with the value indicated in the examples.

In the present invention, the amount of each component in the composition means, when multiple substances corresponding to each component are present in the composition, the total amount of the multiple substances that are present in the composition, unless otherwise specified.

In the present invention, the term “step” includes not only an independent step, but also a step that is not clearly distinguished from another step but that achieves the intended purpose of the step.

In the present invention, “% by mass” and “% by weight” are synonymous, and “parts by mass” and “parts by weight” are synonymous.

Further, in the present invention, a combination of two or more preferable embodiments is a more preferable embodiment.

Further, “(meth)acrylic” herein represents both an acrylic and a methacrylic, or either of them.

Furthermore, in some of the compounds herein, the hydrocarbon chain may be expressed by a simplified structural formula that omits the symbols of carbon (C) and hydrogen (H).

Hereinafter, the present invention will be described in detail.

(Resin Composition)

The resin composition of the present invention contains a polyester polyurethane resin (A), an epoxy resin (B), and a polyamide resin (C).

The resin composition of the present invention can be preferably used as an adhesive composition, can be more preferably used as an adhesive composition for adhesion with polyimides or metals, and can be particularly preferably used as an adhesive composition for adhesion between polyimides and metals.

The present inventors have found that conventional resin compositions are not sufficient in terms of conductivity after a long-term storage under environment of high temperature and high humidity.

The present inventors have found, as a result of intensive studies, that three kinds of resins, accordingly, the polyester polyurethane resin (A), the epoxy resin (B), and the polyamide resin (C) are contained, by which, although the detailed mechanism is not clear, these three kinds of resins act in concert with each other and complement each other to make it possible to provide a resin composition that is excellent in conductivity even after a long-term storage under environment of high temperature and high humidity.

Further, the resin composition of the present invention is also excellent in adhesiveness and solder heat resistance by containing the three kinds of resins, accordingly, the polyester polyurethane resin (A), the epoxy resin (B), and the polyamide resin (C).

In particular, the resin composition of the present invention is high in adhesive force with polyimides and metals, excellent in conductivity at initial stage and after soldering, and also excellent in heat resistance by containing the three kinds of resins, accordingly, the polyester polyurethane resin (A), the epoxy resin (B), and the polyamide resin (C).

Hereinafter, the present invention will be described in detail.

Herein, “polyester polyurethane resin (A)” and the like are also referred to as “component (A)” and the like.

<Polyester Polyurethane Resin (A)>

The resin composition of the present invention contains a polyester polyurethane resin (A).

The polyester polyurethane resin (A) may be a resin having two or more ester bonds and two or more urethane bonds, and is preferably a resin having a polyester chain and two or more urethane bonds.

Further, the polyester polyurethane resin (A) is preferably a resin that is obtained by a reaction of at least a polyester polyol, a polyisocyanate, and a chain extender as raw materials thereof, and is more preferably a resin that is obtained by a reaction of at least a polyester polyol, a polyisocyanate, and a diol compound.

The polyester portion of the polyester polyurethane resin (A) is preferably formed from an acid component and an alcohol component.

As the acid component, a polyvalent carboxylic acid compound is preferable, and a dicarboxylic acid compound is more preferable. Further, as the acid component, a sulfocarboxylic acid compound or the like can also be used. Further, preferred examples of the acid component include an aromatic acid.

As the alcohol component, a polyvalent alcohol compound is preferable, and a diol compound is more preferable.

Further, the polyester portion may be formed from a hydroxycarboxylic acid compound.

When the total amount of the whole acid component configuring the polyester portion of the polyester polyurethane resin (A) is 100 mol %, the aromatic acid is preferably 30 mol % or more, more preferably 45 mol % or more, and particularly preferably 60 mol % or more of the whole acid component, from the viewpoint of adhesiveness, heat resistance and, moist heat resistance.

Examples of the aromatic acid include aromatic dicarboxylic acids, such as terephthalic acid, isophthalic acid, orthophthalic acid, naphthalenedicarboxylic acid, biphenyldicarboxylic acid, and 5-hydroxyisophthalic acid. Also, examples thereof can include: an aromatic dicarboxylic acid having a sulfonic acid group or a sulfonate group, such as sulfoterephthalic acid, 5-sulfoisophthalic acid, 4-sulfophthalic acid, 4-sulfonaphthalene-2,7-dicarboxylic acid, 5-(4-sulfophenoxy)isophthalic acid, sulfoterephthalic acid, a metal salt thereof, and an ammonium salt thereof; and an aromatic oxycarboxylic acid, such as p-hydroxybenzoic acid, p-hydroxyphenylpropionic acid, p-hydroxyphenylacetic acid, 6-hydroxy-2-naphthoic acid, 4,4-bis(p-hydroxyphenyl)valeric acid. Among these, from the viewpoint of adhesiveness, the acid component preferably includes at least one of terephthalic acid or isophthalic acid, and is particularly preferably at least one of terephthalic acid or isophthalic acid.

Further, the acid component may be a derivative of an acid compound, such as an ester, at the time of resin synthesis.

Other examples of the acid component can include: alicyclic dicarboxylic acids, such as 1,4-cyclohexanedicarboxylic acid, 1,3-cyclohexanedicarboxylic acid, 1,2-cyclohexanedicarboxylic acid and its acid anhydride; and aliphatic dicarboxylic acids, such as succinic acid, adipic acid, azelaic acid, sebacic acid, dodecanedioic acid, and dimer acid.

On the other hand, preferred examples of the polyvalent alcohol component include aliphatic diol compounds, alicyclic diol compounds, aromatic-containing diol compounds, and ether bond-containing diol compounds.

Examples of the aliphatic diol compound can include ethylene glycol, 1,2-propanediol, 1,3-propanediol, 1,4-butanediol, 1,5-pentanediol, neopentyl glycol, 1,6-hexanediol, 3-methyl-1,5-pentanediol, 1,9-nonanediol, 2-butyl-2-ethyl-1,3-propanediol, neopentyl glycol hydroxypivalate, dimethylol heptane, and 2,2,4-trimethyl-1,3-pentanediol.

Examples of the alicyclic diol compound can include 1,4-cyclohexanediol, 1,4-cyclohexanedimethanol, tricyclodecanediol, tricyclodecanedimethylol, a spiroglycol, hydrogenated bisphenol A, an ethylene oxide adduct of hydrogenated bisphenol A, and a propylene oxide adduct of hydrogenated bisphenol A.

Examples of the aromatic-containing diol compound can include paraxylene glycol, metaxylene glycol, orthoxylene glycol, 1,4-phenylene glycol, an ethylene oxide adduct of 1,4-phenylene glycol, bisphenol A, and a glycol that is obtained by adding 1 mol to several mots of ethylene oxide or propylene oxide to two phenolic hydroxyl groups of a bisphenol, such as an ethylene oxide adduct of bisphenol A and a propylene oxide adduct of bisphenol A.

Examples of the ether bond-containing diol compound include diethylene glycol, triethylene glycol, dipropylene glycol, polyethylene glycol, polypropylene glycol, polytetramethylene glycol, an ethylene oxide adduct of neopentyl glycol, and a propylene oxide adduct of neopentyl glycol.

Among these diols, a diol having a side chain, such as neopentyl glycol and 2-butyl-2-ethyl-1,3-propanediol, is preferable due to compatibility with epoxy resins, polyamide resins, or the like and solution stability.

Accordingly, the diol component configuring the polyester polyurethane resin (A) preferably includes a diol having a side chain, from the viewpoints of compatibility with epoxy resins, polyamide resins, or the like and solution stability.

Above all from the viewpoints of compatibility with epoxy resins, polyamide resins, or the like, solution stability, and conductivity, the chain extender configuring the polyester polyurethane resin (A) preferably includes a diol having a side chain. Accordingly, the polyester polyurethane resin (A) is preferably a resin that is obtained by a reaction of at least a polyester polyol, a polyisocyanate, and a diol having a side chain as raw materials thereof, from the viewpoints of compatibility with epoxy resins, polyamide resins, or the like, solution stability, and conductivity.

In addition, a hydroxycarboxylic acid compound having a hydroxy group and a carboxy group in the molecular structure can also be used as the polyester raw material, examples of which can include 5-hydroxyisophthalic acid, p-hydroxybenzoic acid, p-hydroxyphenetyl alcohol, p-hydroxyphenylpropionic acid, p-hydroxyphenylacetic acid, 6-hydroxy-2-naphthoic acid, and 4,4-bis(p-hydroxyphenyl)valeric acid.

As the component configuring the polyester portion of the polyester polyurethane resin (A), a tri- or higher functional polycarboxylic acid and/or polyol may be further copolymerized at a ratio of from about 0.1 mol % to about 5 mol % with respect to the whole acid component or the whole polyvalent alcohol component that configures the polyester portion, for the purpose of introducing a branched skeleton as needed. In particular, in the case of reacting with a curing agent to obtain a cured layer, introduction of a branched skeleton increases terminal group density (reaction site) of the resin, by which a cured layer that is high in crosslinking density can be obtained. Examples of the tri- or higher functional polycarboxylic acid that can be used in this case include a compound, such as trimellitic acid, trimesic acid, ethyleneglycol bis(anhydrotrimellitate), glycerol tris(anhydrotrimellitate), trimellitic anhydride, pyromellitic anhydride (PMDA), oxydiphthalic dianhydride (ODPA), 3,3′,4,4′-benzophenone tetracarboxylic dianhydride (BTDA), 3,3′,4,4′-diphenyltetracarboxylic dianhydride (BPDA), 3,3′,4,4′-diphenylsulfonetetracarboxylic dianhydride (DSDA), 4,4′-(hexafluoroisopropylidene)diphthalic dianhydride (6FDA), and 2,2′-bis[(dicarboxyphenoxy)phenyl]propane dianhydride (BSAA). On the other hand, examples of the tri- or higher functional polyol that can be used include glycerin, trimethylolethane, trimethylolpropane, and pentaerythritol. In the case of using the tri- or higher functional polycarboxylic acid and/or polyol, it may be copolymerized preferably in a range of from 0.1 mol % to 5 mol %, and more preferably in a range of from 0.1 mol % to 3 mol %, with respect to the whole acid component or the whole polyvalent alcohol component.

Acid addition of from about 0.1 mol % to about 10 mol % can be performed with respect to the whole acid component or the whole polyvalent alcohol component that configures the polyester portion, for the purpose of introducing a carboxy group into the polyester portion of the polyester polyurethane resin (A) as needed. Since use of a monocarboxylic acid, a dicarboxylic acid, or a polyfunctional carboxylic acid compound for acid addition causes decrease in molecular weight due to transesterification, it is preferable to use an acid anhydride.

As the acid anhydride, a compound, such as succinic anhydride, maleic anhydride, orthophthalic acid, 2,5-norbornenedicarboxylic anhydride, tetrahydrophthalic anhydride, trimellitic anhydride, pyromellitic anhydride (PMDA), oxydiphthalic dianhydride (ODPA), 3,3′,4,4′-benzophenonetetracarboxylic dianhydride (BTDA), 3,3′,4′-diphenyltetracarboxylic dianhydride (BPDA), 3,3′,4,4′-diphenylsulfontetracarboxylic dianhydride (DSDA), (hexafluoroisopropylidene)diphthalic dianhydride (6FDA), and 2,2′-bis[(dicarboxyphenoxy)phenyl]propane dianhydride (BSAA), can be used.

Acid addition can be carried out, after polyester polycondensation, directly in a bulk state or by solubilizing the polyester and carrying out the addition. The reaction in a hulk state progresses quickly. However, when acid addition is carried out in a large amount, gelation may occur and the reaction may progress at a high temperature; therefore, care is required in terms, for example, of blocking oxygen gas to prevent oxidation. On the other hand, the reaction of acid addition in a solution state progresses slowly, but a large amount of carboxy groups can be stably introduced.

The polyisocyanate that is used for producing the polyester polyurethane resin (A) may be: one of a diisocyanate, a dimer thereof (uretdione), a trimer thereof (isocyanurate, triol adduct, burette), or the like; or a mixture of two or more thereof. Examples of the diisocyanate component include 2,4-tolylene diisocyanate, 2,6-tolylene diisocyanate, p-phenylene diisocyanate, diphenylmethane diisocyanate, m-phenylene diisocyanate, hexamethylene diisocyanate, tetramethylene diisocyanate, 3,3′-dimethoxy-4,4′-biphenylene diisocyanate, 1,5-naphthalene diisocyanate, 2,6-naphthalene diisocyanate, 4,4′-diisocyanate diphenyl ether, m-xylylene diisocyanate, 1,3-diisocyanate methylcyclohexane, 1,4-diisocyanate methylcyclohexane, 4,4′-diisocyanate cyclohexane, 4,4′-diisocyanate cyclohexylmethane, isophorone diisocyanate, dimer acid diisocyanate, and norbornene diisocyanate. Among these, an aliphatic or alicyclic diisocyanate is preferable from the viewpoint of transparency. Further, hexamethylene diisocyanate or isophorone diisocyanate is particularly preferable due to availability and economic reasons.

If necessary, a chain extender may be used in producing the polyester polyurethane resin (A).

Examples of the chain extender include: the diol compound described above as a constituent component of the polyester portion; and a compound having one carboxy group and two hydroxy groups, such as dimethylolpropionic acid and dimethylolbutanoic acid.

Among these, from the viewpoint of conductivity, the chain extender is preferably a diol compound, more preferably a diol compound having a side chain, and particularly preferably a diol compound having a branched chain.

From the viewpoint of conductivity, the diol compound having a side chain preferably includes at least one compound selected from the group consisting of neopentyl glycol, 2-butyl-2-ethyl-1,3-propanediol, and 2,2-dimethylolpropionic acid, and particularly preferably includes 2,2-dimethylolpropionic acid and at least one compound selected from the group consisting of neopentyl glycol and 2-butyl-2-ethyl-1,3-propanediol.

The method of producing the polyester polyurethane resin (A) is not particularly limited, and a publically known method can be used. For example, the polyester polyol, the polyisocyanate, and the optional chain extender may be charged collectively or may be charged separately in a reaction vessel. In any case, the reaction is carried out at a ratio of functional group of isocyanate group/hydroxy group of preferably from 0.9 to 1.1, more preferably from 0.98 to 1.02, and particularly preferably 1, which relates to the total hydroxyl value of the polyester polyol and the chain extender, and the entirety of isocyanate groups of the polyisocyanate in the system. Further, this reaction can be carried out under the presence or absence of a solvent that is inert to isocyanate groups, thereby enabling the production. Examples of the solvent include ester-based solvents (such as ethyl acetate, butyl acetate, ethyl butyrate), ether-based solvents (such as dioxane, tetrahydrofuran, diethyl ether), ketone-based solvents (such as cyclohexanone, methyl ethyl ketone, methyl isobutyl ketone), aromatic hydrocarbon-based solvents (such as benzene, toluene, xylene), and mixed solvents thereof, and ethyl acetate or methyl ethyl ketone is preferable from the viewpoint of reduction in environmental load. The reaction apparatus is not limited to a reaction can equipped with a stirring apparatus, and a mixing-kneading apparatus such as a kneader or a twin-screw extruder can also be used therefor.

In order to promote the urethane reaction, it is possible to use a catalyst that is used in ordinary urethane reactions, examples of which include tin-based catalysts (such as trimethyltin laurate, dimethyltin dilaurate, trimethyltin hydroxide, dimethyltin dihydroxide, stannous octoate), lead-based catalysts (such as lead oleate, lead-2-ethylhexoate), and amine-based catalysts (such as triethylamine, tributylamine, morpholine, diazabicyclooctane, diazabicycloundecene).

The glass transition temperature (Tg) of the polyester portion of the polyester polyurethane resin (A) is preferably from 40° C. to 150° C., more preferably from 45° C. to 120° C., further preferably from 50° C. to 90° C., and particularly preferably from 60° C. to 70° C., from the viewpoints of adhesiveness, conductivity, and heat resistance.

Further, the glass transition temperature (Tg) of the polyester polyurethane resin (A) is preferably from 30° C. to 150° C., more preferably from 40° C. to 140° C., and particularly preferably from 50° C. to 120° C., from the viewpoints of adhesiveness, conductivity, and heat resistance.

The number average molecular weight (Mn) of the polyester polyurethane resin (A) is preferably from 5,000 to 100,000, more preferably from 10,000 to 80,000, further preferably from 20,000 to 60,000, and particularly preferably from 25,000 to 50,000, from the viewpoints of conductivity and heat resistance.

The values of the number average molecular weight (Mn) and the weight average molecular weight (Mw) of the resin in the present invention can be obtained by gel permeation chromatography (GPC), respectively.

The molecular weight per urethane bond in the polyester polyurethane resin is preferably from 100 to 15,000, more preferably from 200 to 8,000, and particularly preferably from 300 to 2,000, from the viewpoints of conductivity and heat resistance.

The acid value of the polyester polyurethane resin (A) is preferably from 0 mgKOH/g to 50 mgKOH/g, more preferably from 0.1 mgKOH/g to 20 mgKOH/g, and particularly preferably from 0.1 mgKOH/g to 5 mgKOH/g, from the viewpoints of adhesiveness and conductivity.

The acid value of the polyester polyurethane resin (A) is preferably from 20 mgKOH/g or less, and particularly preferably 5 mgKOH/g or less, from the viewpoint of heat resistance.

The acid value of the resin in the present invention is determined by a measurement method of neutralization titration of a sample with a potassium hydroxide benzyl alcohol solution using a phenolphthalein solution as an indicator.

Among these, the polyester polyurethane resin (A) has a polyester structure of which number average molecular weight is preferably of from 1,000 to 50,000, more preferably from 2,000 to 40,000, further preferably from 3,000 to 30,000, and particularly^{,} preferably from 8,000 to 30,000, from the viewpoints of adhesiveness, conductivity, and heat resistance.

The resin composition of the present invention may contain the polyester polyurethane resin (A) singly or in combination of two or more thereof.

The content of the polyester polyurethane resin (A) is preferably from 5% by mass to 90% by mass, more preferably from 10% by mass to 80% by mass, further preferably from 20% by mass to 75% by mass, and particularly preferably from 30% by mass to 70% by mass, with respect to the total solid content of the resin composition, from the viewpoints of adhesiveness, conductivity, and heat resistance.

The content of the polyester polyurethane resin (A) is preferably from 5% by mass to 90% by mass, more preferably from 10% by mass to 70% by mass, and particularly preferably from 30% by mass to 70% by mass, with respect to the total amount of the polyester polyurethane resin (A), the epoxy resin (B), the polyimide resin (C), and the imidazole silane compound (E) that may be contained as an optional component in the resin composition, from the viewpoints of adhesiveness, conductivity and heat resistance.

<Epoxy Resin (B)>

The resin composition of the present invention contains an epoxy resin (B).

The epoxy resin (B) is a component that imparts adhesiveness, heat resistance to a cured portion after adhesion, and the like. The epoxy resin (B) in the present invention encompasses not only a polymer compound that has an epoxy group but also a low molecule compound that has an epoxy group. The number of epoxy group in the epoxy resin (B) is preferably 2 or more.

Examples of the epoxy resin (B) include: glycidyl esters, such as orthophthalic acid diglycidyl ester, isophthalic acid diglycidyl ester, terephthalic acid diglycidyl ester, p-hydroxybenzoic acid diglycidyl ester, tetrahydrophthalic acid diglycidyl ester, succinic acid diglycidyl ester, adipic acid diglycidyl ester, sebacic acid diglycidyl ester, trimellitic acid triglycidyl ester; glycidyl ethers, such as a diglycidyl ether of bisphenol A and an oligomer thereof, ethylene glycol diglycidyl ether, propylene glycol diglycidyl ether, 1,4-butanediol diglycidyl ether, 1,6-hexanediol diglycidyl ether, trimethylolpropane triglycidyl ether, pentaerythritol tetraglycidyl ether, tetraphenyl glycidyl ether ethane, triphenyl glycidyl ether ethane, a polyglycidyl ether of sorbitol, a polyglycidyl ether of polyglycerol; novolac type epoxy resins, such as a phenol novolac epoxy resin, an o-cresol novolak epoxy resin, a bisphenol A novolak epoxy resin.

Further, a brominated bisphenol A type epoxy resin to which flame-retardance is imparted, a phosphorus-containing epoxy resin, a dicyclopentadiene skeleton-containing epoxy resin, a naphthalene skeleton-containing epoxy resin, an anthracene type epoxy resin, a tertiary butyl catechol type epoxy resin, a biphenyl type epoxy resin, a bisphenol S type epoxy resin, and the like can also be used.

Among these, the epoxy resin (B) preferably includes at least one of a bisphenol A type epoxy resin or a novolak type epoxy resin, from the viewpoints of adhesiveness and heat resistance.

In the present invention, the epoxy resin (B) preferably includes a compound that has three or more epoxy groups in one molecule, in order to achieve high heat resistance after curing. When such a compound is used, cross-linking reactivity with the polyester urethane resin (A) and the polyamide resin (C) is higher than the case of using an epoxy resin that has two epoxy groups, resulting in that sufficient heat resistance can be obtained.

The content of the compound that has three or more epoxy groups in one molecule the epoxy resin (B) is preferably 15% by mass or more, more preferably 20% by mass or more, and particularly preferably 25% by mass or more, with respect to the total mass of the epoxy resin (B), from the viewpoint of heat resistance.

The resin composition of the present invention may contain the epoxy resin (B) singly or in combination of two or more thereof.

The content of the epoxy resin (B) is preferably from 1% by mass to 60% by mass, more preferably from 2% by mass to 40% by mass, and particularly preferably from 3% by mass to 20% by mass, with respect to the total amount of the polyester polyurethane resin (A), the epoxy resin (B), the polyamide resin (C), and the imidazole silane compound (E) that may be contained as an optional component in the resin composition, from the viewpoints of adhesiveness, conductivity, and heat resistance.

<Polyamide Resin (C)>

The resin composition of the present invention contains a polyamide resin (C).

The polyamide resin (C) is a component that imparts adhesiveness, flexibility of a cured product, and the like.

The polyamide resin (C) is preferably solid at 25° C.

The polyamide resin (C) is not particularly limited as long as it is a resin soluble in an organic solvent described later, and specific examples thereof include a copolymerized polyamide resin that is obtained by polycondensation of a dibasic acid and a diamine, and a modified polyamide resin in which an N-alkoxymethyl group has been introduced into an amide bond.

The copolymerized polyamide resin is a condensed resin that is obtained by using a dibasic acid and a diamine as monomers, and is preferably a resin that is obtained by using two or more dibasic acids and two or more diamines. Specific examples of the dibasic acid include adipic acid, sebacic acid, azelaic acid, undecanedioic acid, dodecanedioic acid, dimer acid, isophthalic acid, terephthalic acid, and sodium 5-sulfoisophthalate. Specific examples of the diamine include hexamethylenediamine, heptamethylenediamine, p-diaminomethylcyclohexane, bis(p-aminocyclohexyl)methane, m-xylenediamine, piperazine, and isophoronediamine.

Inclusion of piperazine as the diamine component is preferable for the reason of improvement in adhesiveness. The content of piperazine that is included is preferably 1.0 mol % or more, and more preferably 20 mol % or more, when the total amount of the diamine component configuring the polyamide resin (C) is 100 mol %.

When the copolymerized polyamide resin includes, particularly, a structural unit derived from an aliphatic dibasic acid and a structural unit derived from an alicyclic diamine, solubility in a solvent is excellent. Further, even if an adhesive composition that includes such a copolymerized polyamide resin is stored for a long term, there is almost no increase in viscosity and favorable adhesiveness to a wide range of adherends is exhibited, which is preferable.

The copolymerized polyamide resin may appropriately include a structural unit derived from an aminocarboxylic acid, a lactam, or the like. Specific examples of the aminocarboxylic acid include 11-aminoundecanoic acid, 12-aminododecanoic acid, 4-aminomethylbenzoic acid, and 4-aminomethylcyclohexanecarboxylic acid, and specific examples of the lactam include ε-caprolactam, ω-laurolactam, α-pyrrolidone, and α-piperidone.

Further, the copolymerized polyamide resin may appropriately include a structural unit derived from a polyalkylene glycol, for the purpose of imparting flexibility. Specific examples of the polyalkylene glycol include polyethylene glycol, polypropylene glycol, polytetramethylene glycol, a block or random copolymer of ethylene oxide and propylene oxide, and a block or random copolymer of ethylene oxide and tetrahydrofuran. The structural unit derived from a polyalkylene glycol may be included singly or in combination of two or more thereof.

The copolymerized polyamide resin can have a configuration of, for example, a nylon 6/nylon 66 copolymer, a nylon 6/nylon 6-10 copolymer, a nylon 6/nylon 66/nylon 6-10 copolymer, a nylon 6/nylon 66/nylon 11 copolymer, a nylon 6/nylon 66/nylon 12 copolymer, a nylon 6/nylon 6-10/nylon 6-11 copolymer, a nylon 6/nylon 11/isophorone diamine copolymer, a nylon 6/nylon 66/nylon 6 copolymer, and a nylon 6/nylon 6-10/nylon 12 copolymer.

The modified polyamide resin is an alcohol-soluble nylon resin that is obtained by adding formaldehyde and an alcohol to an unmodified polyamide resin to introduce an alkoxymethyl group into the nitrogen atom configuring an amide bond. Specific examples thereof include a modified polyamide resin that is obtained by alkoxymethylating 6-nylon, 66-nylon, or the like. The introduction of an N-alkoxymethyl group contributes to decrease in melting point, increase in flexibility, and improvement in solubility in a solvent, and the introduction rate is appropriately set according to the purpose.

The amine value of the polyamide resin (C) is not particularly limited. Generally, when the amine value of the polyamide resin is high, the reaction between the amino group and the epoxy group progresses quickly and favorable curability can be obtained by heat treatment in a short time. However, the reaction gradually progresses immediately after mixing the polyamide resin (C) and the epoxy resin (B), as a result of which the viscosity of the composition may increase significantly or gelation may occur. Therefore, selection of the amine value of the polyamide resin (C) enables curability and stability to be balanced. The preferred range of the amine value of the polyamide resin (C) is from 1 mgKOH/g to 6 mgKOH/g.

The melting point of the polyamide resin (C) is not particularly limited, and is preferably in a range of from 50° C. to 220° C., and more preferably in a range of from 70° C. to 180° C., from the viewpoints of solubility in a solvent and heat resistance of a cured product.

Examples of the solvent for dissolving the polyamide resin (C) include: alcohols, such as methanol, ethanol, isopropyl alcohol, n-propyl alcohol, isobutyl alcohol, n-butyl alcohol, benzyl alcohol, ethylene glycol monomethyl ether, propylene glycol monomethyl ether, diethylene glycol monomethyl ether, diacetone alcohol; ketones, such as acetone, methyl ethyl ketone, methyl isobutyl ketone, methyl amyl ketone, cyclohexanone, isophorone; aromatic hydrocarbons, such as toluene, xylene, ethylbenzene, mesityrene; and esters, such as methyl acetate, ethyl acetate, ethylene glycol monomethyl ether acetone, 3-methoxybutyl acetate. These solvents may be used singly or in combination of two or more thereof.

The resin composition of the present invention may contain the polyamide resin (C) singly or in combination of two or more thereof.

The content of the polyamide resin (C) is preferably from 5% by mass to 90% by mass, more preferably from 10% by mass to 70% by mass, and particularly preferably from 30% by mass to 70% by mass, with respect to the total amount of the polyester polyurethane resin (A), the epoxy resin (B), the polyamide resin (C), and the imidazole silane compound (E) that may be contained as an optional component in the resin composition, from the viewpoints of adhesiveness, conductivity and heat resistance.

The content of the polyester polyurethane resin (A) and the polyamide resin (C) in the resin composition is preferably from 50% by mass to 98% by mass, more preferably from 70% by mass to 97% by mass, and particularly preferably from 75% by mass to 95% by mass, with respect to the total amount of the polyester polyurethane resin (A), the epoxy resin (B), the polyamide resin (C), and the imidazole silane compound (F) that may be contained as an optional component in the resin composition, from the viewpoints of adhesiveness, conductivity and heat resistance.

<Organic Filler (D)>

The resin composition of the present invention preferably contains an organic filler (D), from the viewpoints of elongation, conductivity, and moist heat resistance of a resulting cured product.

Examples of the organic filler (D) include (meth)acrylic resin particles, polybutadiene particles, nylon fine particles, polyolefin particles, polyester particles, polycarbonate particles, polyvinyl alcohol particles, polyvinyl ether particles, polyvinyl butyral particles, silicone rubber particles, polyurethane particles, phenolic resin particles, and polytetrafluorinated ethylene particles.

It has been found that, when dissolved with the polyester polyurethane resin (A), the epoxy resin (B), and the polyamide resin (C), the organic filler has an effect of enhancing the compatibility of these resins. Further, from the viewpoint of further improving the compatibility and liquid stability of these resins, silicone particles, polybutadiene particles, (meth)acrylic resin particles, and polyurethane particles are particularly preferable.

The average particle diameter of the organic filler (D) is not particularly limited, and is preferably from 0.5 μm to 50 μm, and more preferably from 1 μm to 30 μm, from the viewpoints of coatability and adjustability of coating thickness.

The resin composition of the present invention may contain the organic filler (D) singly or in combination of two or more thereof.

The content of the organic filler (D) is preferably from 1 parts by mass to 50 parts by mass, more preferably from 5 parts by mass to 40 parts by mass, and particularly preferably from 10 parts by mass to 20 parts by mass, with respect to the total amount, of 100 parts by mass, of the polyester polyurethane resin (A), the epoxy resin (B), the polyamide resin (C), and the imidazole silane compound (E) that may be contained as an optional component in the resin composition, from the viewpoints of adhesiveness, conductivity, and curability.

<Imidazole Silane Compound (E)>

The resin composition of the present invention preferably contains an imidazole silane compound (E), from the viewpoints of conductivity and adhesiveness.

The imidazole silane compound (E) is a compound that has one or more imidazole ring structures and one or more silane structures, and is presumed to serve as a curing agent for the epoxy resin (B).

The imidazole silane compound (E) is preferably a compound that has one imidazole ring structure and one silyl group from the viewpoints of conductivity and adhesiveness.

Further, preferred examples of the imidazole silane compound (E) include a compound represented by the following formula (E) and an acid adduct thereof, from the viewpoints of conductivity and adhesiveness.

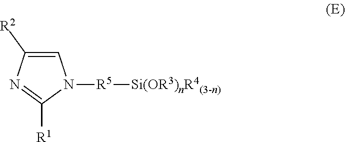

In the formula (E), R¹ and R² each independently represent a hydrogen atom, a saturated hydrocarbon group, an unsaturated hydrocarbon group, or an aryl group, in which each of the groups may have a substituent, R³'s and R⁴'s each independently represent a hydrogen atom or an alkyl group, in which at least one of R³'s is an alkyl group and the alkyl group may have a substituent, n represents an integer of 1 to 3, and R⁵ represents an alkylene group or a group in which a part of an alkylene group is substituted with at least one selected from the group consisting of the following formula (E2) to formula (E5).

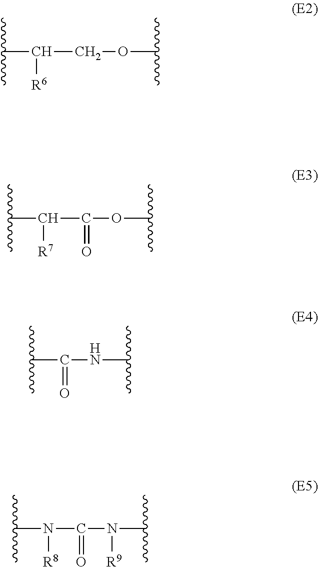

In the formula (E2), the formula (E3), and the formula (E5), R⁶ represents a hydrogen atom or a hydroxy group, R⁷ represents a hydrogen atom, an alkyl group, or an aryl group, R⁸ and R⁹ each independently represent a hydrogen atom, an alkyl group, or an aryl group, in which each of the groups may have a substituent, and the wavy line portion represents a bonding site with another structure.

When the imidazole silane compound (E), particularly the compound represented by the formula (E) is contained, adhesiveness to a metal, particularly to a gold-plated copper foil is improved. The reason for this is presumed to be that, since the silane structure and the imidazole ring structure exhibit high affinity with both the gold interface and the polyamide resin (C), the adhesiveness can be improved by their interaction. Further, it is presumed that, since the imidazole ring structure also may react with the epoxy resin (B), the effect of improving the adhesiveness can be maintained even in the reflow step described later.

The imidazole silane compound (E) is preferably a compound that has, in one molecule, an imidazole ring structure as a first functional group and an alkoxysilyl group as a second functional group.

The imidazole ring in the imidazole ring structure may have a substituent such as a saturated hydrocarbon group or an unsaturated hydrocarbon group.

In the formula (E), when R¹, R², R³'s, and R⁴'s are each independently an alkyl group, the number of carbon is preferably 1 to 3.

Examples of the imidazole ring structure configuring the imidazole silane compound (E) include an imidazole ring structure, a 2-alkylimidazole ring structure, a 2,4-dialkylimidazole ring structure, and a 4-vinylimidazole ring structure.

In the imidazole silane compound (E), the alkoxysilyl group and the imidazole ring structure are preferably bonded to each other via an alkylene group or a group in which a part of an alkylene group is substituted with at least one selected from the group consisting of the formula (E2) to formula (E5).

The number of carbon of the alkylene group in R⁵ of the formula (E) is preferably 1 to 10, and more preferably 3 to 7.

The imidazole silane compound (E) can be preferably synthesized by, for example, a reaction of an imidazole compound and a 3-glycidoxyalkylsilane compound or the like.

Further, the imidazole silane compound (E) may be a silanol compound that is produced by hydrolysis of an alkoxysilyl group, may be a polyorganosiloxane compound that is produced by a dehydration condensation reaction of a silanol compound, or may be a mixture thereof.

Examples of the acid that is added to the compound represented by the formula (E) include acetic acid, lactic acid, salicylic acid, benzoic acid, adipic acid, phthalic acid, citric acid, tartrate acid, maleic acid, trimellitic acid, phosphoric acid, and isocyanuric acid. These can be used singly or in combination of two or more thereof.

Further, the imidazole silane compound (E) is more preferably a compound represented by the following formula (E6) or formula (E7), or an acid adduct thereof, from the viewpoints of conductivity and adhesiveness.

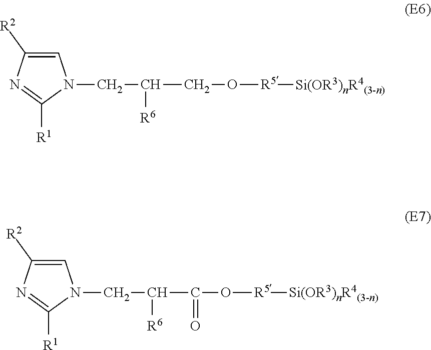

In the formula (E6) and the formula (E7), R¹ and R² each independently represent hydrogen atom, a saturated hydrocarbon group, an unsaturated hydrocarbon group, or an aryl group, in which each of the groups may have a substituent, R³'s and R⁴'s each independently represent a hydrogen atom or an alkyl group, in which at least one of les is an alkyl group and the alkyl group may have a substituent, n represents an integer of 1 to 3, R⁵′ represents an alkylene group, and R⁶ represents a hydrogen atom or a hydroxy group.

The number of carbon of the alkylene group in R⁵′ of the formula (E6) and the formula (E7) is preferably 1 to 10, and more preferably 3 to 7.

Specific examples of the imidazole silane compound (E) include 1-(2-hydroxy-3-trimethoxysilylpropoxypropyl)imidazole, 1-(2-hydroxy-3-triethoxysilylpropoxypropyl)imidazole, 1-(2-hydroxy-3-tripropoxysilylpropoxypropyl)imidazole, 1-(2-hydroxy-3-tributoxysilylpropoxypropyl)imidazole, 1-(2-hydroxy-3-triethoxysilylpropoxypropyl)-2-methylimidazole, 1-(2-hydroxy-3-triethoxysilylpropoxypropyl)-4-methylimidazole, 1-(3-oxo-4-trimethoxysilylpropoxypropyl)imidazole, and 1-(3-trimethoxysilylpropylamino)imidazole.

Among these, the compound represented by the formula (E6) or the formula (E7), or an acid adduct thereof is preferable since it is favorable in heat resistance and solubility in a solvent, and an acid adduct of the compound represented by the formula (E6) is more preferable.

The compound represented by the formula (E6) can be preferably obtained by, for example, a reaction of an imidazole compound such as imidazole, an 2-alkylimidazole, a 2,4-dialkylimidazole, and 4-vinylimidazole, with a 3-glycidoxypropylsilane compound such as 3-glycidoxypropyltrialkoxysilane, 3-glycidoxypropyldialkoxyalkylsilane, and 3-glycidoxypropylalkoxydialkylsilane. Among these, particularly preferred is a reaction product of imidazole and 3-glycidoxypropyltrimethoxysilane.

The compound represented by the formula (E7) can be preferably obtained by, for example, a reaction of an imidazole compound and 3-methacryloyloxypropyltrimethoxysilane.

The resin composition of the present invention may contain the imidazole silane compound (E) singly or in combination of two or more thereof.

The content of the imidazole silane compound (E) is preferably from 0.05% by mass to 20% by mass, more preferably from 0.1% by mass to 10% by mass, and particularly preferably from 1% by mass to 5% by mass, with respect to the total amount of the polyester polyurethane resin (A), the epoxy resin (B), the polyamide resin (C), and the imidazole silane compound (E) in the resin composition, from the viewpoints of conductivity and adhesiveness.

<Metal Filler (F)>

The resin composition of the present invention preferably contains a metal filler (F), from the viewpoints of conductivity and heat resistance.

Preferred examples of the metal filler (F) include metal particles made of a conductive metal such as gold, platinum, silver, copper, and nickel, or an alloy thereof. Instead of particles having a single composition, particles having a metal or a resin as a core, a coating layer of which is formed of a highly conductive material, are also preferable from the viewpoint of cost reduction. The core is preferably made of at least one material selected from the group consisting of nickel, silica, copper, and resin, and is more preferably made of a conductive metal or an alloy thereof. The coating layer is preferably a layer made of a material that is excellent in conductivity, and preferably a layer made of a conductive metal or a conductive polymer.

Examples of the conductive metal include gold, platinum, silver, tin, manganese, indium, and an alloy thereof. Examples of the conductive polymer include polyaniline and polyacetylene. Among these, silver is preferable from the viewpoint of conductivity.

From the viewpoints of cost and conductivity, the particles consisting of the core and the coating layer preferably contain the coating layer at a ratio of from 1 parts by mass to 40 parts by mass, and more preferably contain the coating layer at a ratio of from 5 parts by mass to 30 parts by mass, with respect to 100 parts by mass of the core.

The particles consisting of the core and the coating layer are preferably particles in which the coating layer completely covers the core. However, in actual, a part of the core may be exposed. Even in such a case, if the conductive material covers 70% or more of the surface area of the core, conductivity can be easily maintained.

The shape of the metal filler (F) is not limited as long as the desired conductivity can be obtained. Specifically, for example, a spherical shape, a flake shape, a leaf shape, a dendritic shape, a plate shape, a needle shape, a rod shape, or a botryoid shape is preferable.

The average particle diameter of the metal filler (F) is preferably from 1 μm to 100 μm, more preferably from 3 μm to 50 μm, and particularly preferably from 4 μm to 15 μm, from the viewpoints of conductivity and storage stability.

The average particle diameter of particles in the present disclosure is a D50 average particle diameter which is determined by measuring each conductive fine particle powder in a tornado dry powder sample module by means of a laser diffraction/scattering method-particle size distribution measuring device LS 13320 (manufactured by Beckman Coulter), and for which an average of a diameter of particle size at the accumulated value of 50% of the particles is used. The refractive index is set as 1.6.

The average particle diameter of the metal filler (F) can also be determined from an average value of about 20 particles that are randomly selected in the region of an enlarged image (about 1,000× to 10,000× magnification) of an electron microscope. In this case, the average particle diameter is also preferably from 1 μm to 100 μm, more preferably from 3 μm to 50 μm, and particularly preferably from 4 μm to 15 μm. If the metal filler (F) has a long axis direction and a short axis direction (for example, rod-shaped particles), the average particle diameter is calculated in terms of length in the long axis direction.

The resin composition of the present invention may contain the metal filler (F) singly or in combination of two or more thereof.

The content of the metal filler (F) is preferably from 1 parts by mass to 500 parts by mass, more preferably from 10 parts by mass to 350 parts by mass, and particularly preferably from 10 parts by mass to 50 parts by mass, with respect to the total amount, of 100 parts by mass, of the polyester polyurethane resin (A), the epoxy resin (B), and the polyimide resin (C) in the resin composition, from the viewpoints of conductivity, heat resistance, and storage stability.

The resin composition of the present invention may contain an additive other than the components described above.

As the other additive, a thermoplastic resin other than those described above, a tackifier, a flame retardant, a curing agent, a curing promoter, a coupling agent, a heat aging inhibitor, a leveling agent, a defoamer, an inorganic filler, a solvent, or the like can be contained to an extent that the function of the resin composition is not affected.

Examples of the other thermoplastic resin include a phenoxy resin, a polyester resin, a polycarbonate resin, a polyphenylene oxide resin, a polyurethane resin, a polyacetal resin, a polyethylene resin, a polypropylene resin, and a polyvinyl resin. These thermoplastic resins may be used singly or in combination of two or more thereof.

Examples of the tackifier can include a courmarone-inden resin, a terpene resin, a terpene-phenol resin, a rosin resin, a p-t-butylphenol-acetylene resin, a phenol-formaldehyde resin, a xylene-formaldehyde resin, a petroleum hydrocarbon resin, a hydrogenated hydrocarbon resin, and a turpentine resin. These tackifiers may be used singly or in combination of two or more thereof.

The flame retardant may be either an organic flame retardant or an inorganic flame retardant.

Examples of the organic flame retardant include: a phosphorous flame retardant, such as melamine phosphate, melamine polyphosphate, guanidine phosphate, guanidine polyphosphate, ammonium phosphate, ammonium polyphosphate, ammonium phosphate amide, ammonium polyphosphate amide, carbamate phosphate, carbamate polyphosphate, aluminum trisdiethylphosphinate, aluminum trismethylethylphosphite, aluminum trisdiphenylphosphinate, zinc bisdiethylphosphinate, zinc bismethylethylphosphine, zinc bisdiphenylphosphite, titanyl bisdiethylphosphite, titanium tetrakisdiethylphosphine, titanyl bismethylethylphosphinate, titanium tetrakismethylethylphosphinate, titanyl bisdiphenylphosphinate, titanium tetrakisdiphenylphosphinate; a nitrogen-based flame retardant, such as a triazine compound (such as melamine, melam, melamine cyanurate), a cyanuric acid compound, an isocyanuric acid compound, a triazole compound, a tetrazole compound, a diazo compound, urea; and a silicon-based flame retardant, such as a silicone compound, a silane compound.

Examples of the inorganic flame retardant include a metal hydroxide, such as aluminum hydroxide, magnesium hydroxide, zirconium hydroxide, barium hydroxide, and calcium hydroxide; a metal oxide, such as tin oxide, aluminum oxide, magnesium oxide, zirconium oxide, zinc oxide, molybdenum oxide, and nickel oxide; and zinc carbonate, magnesium carbonate, calcium carbonate, barium carbonate, zinc borate, and hydrated glass.

These flame retardants may be used singly or in combination of two or more thereof.

The curing agent is a component for forming a cross-linked structure by a reaction with the epoxy resin (B), and examples thereof include: an amine-based curing agent, such as an aliphatic diamine, an aliphatic polyamine, a cyclic aliphatic diamine, and an aromatic diamine; a polyamides amine-based curing agent; an acid-based curing agent, such as an aliphatic polyvalent carboxylic acid, an alicyclic polyvalent carboxylic acid, an aromatic polyvalent carboxylic acid, and an acid anhydride thereof; a basic active hydrogen-based curing agent, such as dicyandiamide and an organic acid dihydrazide; a polymercaptan-based curing agent; a novolak resin-based curing agent; a urea resin-based curing agent; and a melamine resin-based curing agent.

These curing agents may be used singly or in combination of two or more thereof.

Examples of the aliphatic diamine-based curing agent include ethylenediamine, 1,3-diaminopropane, 1,4-diaminobutane, hexamethylenediamine, polymethylenediamine, polyetherdiamine, 2,5-dimethylhexamethylenediamine, and trimethylhexamethylenediamine.

Examples of the aliphatic polyamine-based curing agent include diethylenetriamine, iminobis(hexamethylene)triamine, trihexatetramine, tetraethylenepentamine, aminoethylethanolamine, tri(methylamino)hexane, dimethylaminopropylamine, diethylaminopropylamine, and methyliminobispropylamine.

Examples of the cyclic aliphatic diamine-based curing agent include mensendiamine, isophoronediamine, bis(4-amino-3-methyldicyclohexyl)methane, diaminodicyclohexylmethane, bis(aminomethyl)cyclohexane, N-ethylaminopiperazine, 3,9-bis(3-aminopropyl)-2,4,8,10-tetraoxaspiro[5.5]undecane, and a hydrogenated product of m-xylylenediamine.

Examples of the aromatic diamine-based curing agent include m-phenylenediamine, diaminodiphenylmethane, diaminodiphenylsulfone, diaminodiethyldiphenylmethane, and m-xylylenediamine.

Examples of the aliphatic polyvalent carboxylic acid-based curing agent and acid anhydride-based curing agent include succinic acid, adipic acid, dodecenyl succinic anhydride, polyazipic anhydride, polyazelineic anhydride, and polysevacinic anhydride.

Examples of the alicyclic polyvalent carboxylic acid-based curing agent and acid anhydride-based curing agent include methyltetrahydrophthalic acid, methylhexahydrophthalic acid, methylhymic acid, hexahydrophthalic acid, tetrahydrophthalic acid, trialkyltetrahydrophthalic acid, methylcyclodicarboxylic acid, and an acid anhydride thereof.

Examples of the aromatic polyvalent carboxylic acid-based curing agent and acid anhydride-based curing agent include phthalic acid, trimellitic acid, pyromellitic acid, benzophenone tetracarboxylic acid, ethylene glycol glycol bistrimellitic acid, glycerol tristrimellitic acid, and an acid anhydride thereof.

Examples of the polymercaptan-based curing agent include a mercaptoized epoxy resin and a mercaptopropionic acid ester.

Examples of the novolak-based curing agent include a phenol novolac-based curing agent and a cresol novolak-based curing agent.

In the case in which the resin composition of the present invention contains the curing agent, the content of the curing agent is adjusted such that the functional group equivalent thereof is preferably in a range of from 0.2 mole equivalent to 2.5 mole equivalent, and more preferably in a range of from 0.4 mole equivalent to 2.0 mole equivalent, with respect to 1 mole equivalent of epoxy group of the epoxy resin (B), from the viewpoints of adhesiveness and heat resistance.

The curing promoter is a component used for the purpose of promoting the reaction of the epoxy resin (B), and a tertiary amine-based curing promoter, a tertiary amine salt-based curing promoter, an imidazole-based curing promoter, and the like can be used therefor.

These curing promoters may be used singly or in combination of two or more thereof.

Examples of the tertiary amine-based curing promoter include benzyldimethylamine, 2-(dimethylaminomethyl)phenol, tris(dimethylaminomethyl)phenol, tetramethylguanidine, triethanolamine, N,N′-dimethylpiperazine, triethylenediamine, and 1,8-diazabicyclo[5.4.0]undecene.

Examples of the tertiary amine salt-based curing promoter include: formate, octylate, p-toluenesulfonate, o-phthalate, phenol salt, or phenol novolak resin salt of 1,8-diazabicyclo[5.4.0]undecene; and formate, octylate, p-toluenesulfonate, o-phthalate, phenol salt, or phenol novolac resin salt of 1,5-diazabicyclo[4.3.0]nonene.

Examples of the imidazole-based curing promoter include 2-methylimidazole, 2-undecylimidazole, 2-heptadecylimidazole, 1,2-dimethylimidazole, 2-methyl-4-ethylimidazole, 2-phenylimidazole, 2-phenyl-4-methylimidazole, 1-benzyl-2-methylimidazole, 1-benzyl-2-phenylimidazole, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, a 2,4-diamino-6-[2′-methylimidazolyl-(1′)]-ethyl-s-triazine isocyanuric acid adduct, a 2-phenylimidazoleisocyanuric acid adduct, 2-phenyl-4,5-dihydroxymethylimidazole, and 2-phenyl-4-methyl-5-hydroxymethylimidazole.

In the case in which the resin composition of the present invention contains the curing promoter, the content of the curing promoter is preferably in a range of from 1 to 10 parts by mass, and particularly preferably in a range of from 2 to 5 parts by mass, with respect to 100 parts by mass of the epoxy resin (B), from the viewpoints of adhesiveness and heat resistance.

Examples of the coupling agent include: a silane-based coupling agent, such as vinyl trimethoxysilane, 3-glycidoxypropyltrimethoxysilane, p-styryltrimethoxysilane, 3-methacryloxypropylmethyldimethoxysilane, 3-acryloxypropyltrimethoxysilane, N-2-(aminoethyl)-3-aminopropylmethyldimethoxyloxysilane, 3-ureidopropyltriethoxysilane, 3-mercaptopropylmethyldimethoxysilane, bis(triethoxysilylpropyl)tetrasulfide, 3-isocyanatepropyltriethoxysilane, and imidazolesilane; a titanate-based coupling agent; an aluminate-based coupling agent; and a zirconium-based coupling agent. These may be used singly or in combination of two or more thereof.

Examples of the heat aging inhibitor include: a phenol-based antioxidant, such as 2,6-di-tert-butyl-4-methylphenol, n-octadecyl-3-(3′,5′-di-tert-butyl-4′-hydroxyphenyl)propionate, and tetrakis[methylene-3-(3,5-di-tert-butyl-4-hydroxyphenyl)propionate]methane; a sulfur-based antioxidant, such as dilauryl-3,3′-thiodipropionate, and dimyristyl-3,3′-dithiopropionate; and a phosphorus-based antioxidant, such as trisnonylphenyl phosphite, and tris(2,4-di-tert-butylphenyl)phosphite. These may be used singly or in combination of two or more thereof.

Examples of the inorganic filler include a powder made of calcium carbonate, titanium oxide, aluminum oxide, zinc oxide, carbon black, talc, silica, or the like. These may be used singly or in combination of two or more thereof.

The resin composition of the present invention can be prepared by mixing the polyester polyurethane resin (A), the epoxy resin (B), the polyamide resin (C) and, if necessary, the other components.

Since the resin composition of the present invention is preferably used in the state of a solution or a dispersion, it preferably contains a solvent.

Examples of the solvent include: alcohols, such as methanol, ethanol, isopropyl alcohol, n-propyl alcohol, isobutyl alcohol, n-butyl alcohol, benzyl alcohol, ethylene glycol monomethyl ether, propylene glycol monomethyl ether, diethylene glycol monomethyl ether, and diacetone alcohol; ketones, such as acetone, methyl ethyl ketone, methyl isobutyl ketone, methyl amyl ketone, cyclohexanone, and isophorone; aromatic hydrocarbons, such as toluene, xylene, ethylbenzene, mesitylene; esters, such as methyl acetate, ethyl acetate, ethylene glycol monomethyl ether acetate, and 3-methoxybutyl acetate; aliphatic hydrocarbons, such as hexane, heptane, cyclohexane, and methylcyclohexane. These solvents may be used singly or in combination of two or more thereof. When the resin composition of the present invention is in the state of a solution or a dispersion that contains a solvent, coating onto an adherend and formation of a resin composition layer can be facilitated, and a resin composition layer with a desired thickness can be easily obtained.

In the case in which the resin composition of the present invention contains the solvent, the solvent is used such that the solid content concentration is preferably in a range of from 3% by mass to 80% by mass, and more preferably in a range of from 10% by mass to 50% by mass, from the viewpoint of workability that encompasses coating formation ability.

The adherend preferable to the resin composition of the present invention is an object that is made of: a polymer material such as a polyimide resin, a polyetheretherketone resin, a polyphenylene sulfide resin, an aramid resin, and a liquid crystal polymer; a metal material such as copper, aluminum, and stainless, etc. The shape of the adherend is not particularly limited. Two members made of the same materials as or different materials from each other, as adherends, can be adhered each other by the resin composition of the present invention, to produce an integrated composite product. In addition, a product that includes an adhesive resin composition layer, such as a coverlay film and a bonding sheet below, can be produced.

(Layered Body Including Resin Composition Layer and Layered Body)

The layered body including a resin composition layer of the present invention is a layered body including a resin composition layer consisting of the resin composition of the present invention, and preferably includes a resin composition layer consisting of the resin composition of the present invention and a base film that is in contact with at least one surface of the resin composition layer, in which the resin composition layer is in a B-stage state.

In the present invention, that “a resin composition layer is in a B-stage state” means a semi-cured state in which a part of the resin composition layer begins to cure, and the curing of the resin composition layer further progresses by heating or the like.

Further, the resin composition layer consisting of the resin composition of the present invention is, in the case in which the resin composition including a solvent is used, preferably a layer in which at least a part of the solvent has been removed from the resin composition of the present invention.

The layered body of the present invention is preferably a layered body including a cured layer that is obtained by curing a resin composition consisting of the resin composition of the present invention, the layered body including: a cured layer obtained by curing the resin composition of the present invention; and a base film that is in contact with at least one surface of the cured layer.

Each of the layered body including the resin composition layer of the present invention and the layered body of the present invention preferably includes a base material, and more preferably includes, on the base material, a layer consisting of the resin composition of the present invention.

The base material is not particularly limited, and a known base material can be used therefor.

Further, the base material is preferably a film-shaped base material (base film).

The base film is preferably a resin film, more preferably a polyimide film or an aramid film, and particularly preferably a polyimide film.

Neither the polyimide film nor the aramid film is particularly limited as long as it has electrical insulating property, and may be a film made of only a polyimide resin or an aramid resin, a film that contains the resin and an additive, or the like, and the side on which the resin composition layer is formed may have been subject to a surface treatment.

The thickness of the base material is not particularly limited, and is preferably from 3 μm to 125 μm.

The thickness of the resin composition layer is preferably from 5 to 50 μm, and more preferably from 10 μm to 40 μm.

As the method of producing the layered body including the resin composition layer of the present invention, for example, the resin composition of the present invention including a solvent is applied to the surface of a base film such as a polyimide film to form a resin composition layer, followed by removing at least a part of the solvent from the resin composition layer, by which a layered body including a resin composition layer that is in a B-stage state can be produced.

The drying temperature during removing the solvent is preferably from 40° C. to 250° C., and more preferably from 70° C. to 170° C.

The drying is carded out by passing the layered body applied with the resin composition through a furnace in which hot air drying, far-infrared heating, high-frequency induction heating, and the like are performed.

If necessary, the layered body including the resin composition layer of the present invention may further include a releasable film on the surface of the resin composition layer for storage or the like.

As the releasable film, those known such as a polyethylene terephthalate film, a polyethylene film, a polypropylene film, a silicone releasable paper, a polyolefin resin coated paper, a polymethylpentene (TPX) film, and a fluororesin film are used.

The thickness of the resin composition layer in a B-stage state is preferably from 5 μm to 100 μm, more preferably from 5 μm to 70 μm, further preferably from 5 μm to 50 μm, and particularly preferably from 10 μm to 40 μm.

The thickness of each of the base film and the resin composition layer is selected depending on the application, but the base film tends to be thinner in order to improve electrical characteristics. The preferable thickness of the base film is the same as the preferable thickness of the base material described above.

In the layered body including the resin composition layer of the present invention, the ratio (A/B) of the thickness (A) of the resin composition to the thickness (B) of the base film is preferably from 1 to 10, and more preferably from 1 to 5. Further, it is preferable that the thickness of the resin composition layer is larger than the thickness of the base film.

As the method of producing the layered body of the present invention, for example, the resin composition of the present invention including a solvent is applied to the surface of the base film, drying is then performed in the same manner as in the case of the layered body including the resin composition layer of the present invention, followed by bringing the surface of the resin composition layer formed and an adherend into surface contact with each other and performing laminating, for example, thermal laminating at 80° C. to 150° C. Next, a method in which the layered body (base film/resin composition layer/adherend) is subject to thermal compression bonding and then cured by after-cure to form a cured layer is preferable.

The conditions for thermal compression bonding are not particularly limited as long as they enable compression bonding, and can be preferably from 150° C. to 200° C. and a pressure of from 11 MPa to 3 MPa for 1 minute to 60 minutes. The conditions for after-cure are not particularly limited, and can be preferably from 100° C. to 200° C. and from 30 minutes to 4 hours.

The thickness of the cured layer is from preferably from 5 μm to 100 μm, more preferably from 5 μm to 70 μm, further preferably from 5 μm to 50 μm, and particularly preferably from 10 μm to 40 μm.

The adherend is not particularly limited, and examples thereof can include those described above. Among these, examples preferably include a metal adherend, more preferably include a copper foil and a plated copper foil, and particularly preferably include a gold-plated copper foil.

Further, the shape, size, and the like of the adherend are not particularly limited, and those known can be used.

Further, examples of one embodiment of the layered body of the present invention include a flexible copper-clad laminate.

That is, the flexible copper-clad laminate of the present invention preferably include a cured layer obtained by curing a resin composition consisting of the resin composition of the present invention, in which a polyimide film or an aramid film, the cured layer obtained by curing the resin composition of the present invention, and a copper foil are layered.

In the flexible copper-clad laminate of the present invention, the cured layer and the copper foil may be formed on both sides of the polyimide film or the aramid film. Since the resin composition of the present invention is excellent in adhesiveness to an object that contains copper, the flexible copper-clad laminate of the present invention is excellent in stability as an integrated product.

The configuration of the polyimide film or the aramid film is the same as that of the polyimide film or the aramid film in the coverlay film of the present invention described above.

The thickness of the cured layer is preferably from 5 μm to 50 μm, and more preferably from 10 μm to 40 μm.

The copper foil is not particularly limited, and electrolytic copper foil, rolled copper foil, or the like can be used therefore.

Further, the copper foil may be plated with a known metal such as gold or silver, or an alloy.

Examples of one embodiment of the layered body including the resin composition layer of the present invention includes a bonding film, an electromagnetic wave shielding film, and a coverlay film, which will be described later.

Bonding Film

The bonding film of the present invention is a bonding film that includes a resin composition layer consisting of the resin composition of the present invention, and preferably includes a resin composition layer consisting of the resin composition of the present invention and a release film that is in contact with at least one surface of the resin composition layer, in which the resin composition layer is in a B-stage state.

The bonding film of the present invention is also one embodiment of the layered body including a resin composition layer of the present invention, which will be described later.

The bonding film of the present invention may be configured to include a resin composition layer between two releasable films.

As the releasable film. those known as described above are used therefor.

The thickness of the releasable film is preferably from 20 μm to 100 μm.

The thickness of the resin composition layer is preferably from 5 μm to 100 μm, and more preferably from 10 μm to 60 μm.

Examples of the method of producing the bonding sheet of the present invention preferably include a method of applying the resin composition of the present invention including a solvent onto the surface of the releasable film, followed by drying in the same manner as in the case of the layered body including the resin composition layer of the present invention described above.

Electromagnetic Wave Shielding Film

The electromagnetic wave shielding film of the present invention includes a resin composition layer that consists of the resin composition of the present invention, and may include a base film or a release film that is in contact with at least one surface of the resin composition layer.

Further, the electromagnetic wave shielding film of the present invention preferably include the resin composition layer and a protective layer.

The protective layer is not particularly limited as long as it is a layer that consists of an insulating resin composition, and any known can be used therefor. Further, the protective layer may use a resin component that is used for the resin composition of the present invention. Further, the protective layer may be formed of two or more layers that are different from each other in terms of composition or hardness.

If necessary, the protective layer may include a curing promoter, a tackifier, an antioxidant, a pigment, a dye, a plasticizer, an ultraviolet absorber, a defoamer, a leveling agent, a filler, a flame retardant, a viscosity adjuster, an anti-blocking agent, or the like.

The thickness of the resin composition layer in the electromagnetic wave shielding film of the present invention is not particularly limited, and is preferably from 3 μm to 30 μm from the viewpoints of conductivity and connectivity with a gland wiring.

Next, the specific embodiment of the method of producing the electromagnetic wave shielding film of the present invention will be described.

For example, examples thereof can include a method of coating a resin composition for a protective layer onto one surface of a peelable film and drying to form a protective layer, followed by coating the resin composition of the present invention onto the protective layer and drying to form a resin composition layer.

By the production method as exemplified, an electromagnetic wave shielding film in a layered state of resin composition layer/protective layer/peelable film can be obtained.

The method of providing the resin composition layer and the protective layer can be realized by conventionally known coating methods such as gravure coating method, kiss coating method, die coating method, lip coating method, comma coating method, blade coating method, roll coating method, knife coating method, spray coating method, bar coating method, spin coating method, and dip coating method.

The electromagnetic wave shielding film of the present invention can be adhered to a printed wiring board by, for example, a heat press. The resin composition layer is softened by heating and flows into a gland portion provided on the printed wiring board by pressurization. As a result, the gland wiring and the conductive adhesive are electrically connected, and the shielding effect can be enhanced.

### EXAMPLES

Hereinafter, the present invention will be more specifically described based on Examples. The present invention is not limited to these Examples. Further, “parts” and “%” indicated below mean “parts by mass” and “% by mass”, respectively, unless otherwise specified.

1. Raw Materials

1-1. Polyester Resin

Commercial products and synthetic products were used as polyesters to be used in the production of polyester polyurethanes.

<Commercial Product>

As a commercial product, Aronmelt PES-360HVXM30 (trade name; number average molecular weight 20,000) manufactured by Toagosei Co., Ltd. was used.

<Synthesis of Polyester>

In a flask equipped with a stirrer, a nitrogen introduction tube, a distillation tube, and a thermometer, 201 parts by mass of dimethyl terephthalate, 86 parts by mass of ethylene glycol, 140 parts by mass of neopentyl glycol, 0.9 parts by mass of trimethylolpropane, and 0.22 parts by mass of zinc acetate as a catalyst were charged, the temperature was raised while introducing nitrogen to distill off methanol at from 150° C. to 180° C. Then, 183 parts by mass of isophthalic acid, 0.6 parts by mass of trimethylolpropane, and 0.12 parts by mass of antimony trioxide as a catalyst were added, and water was distilled off at from 180° C. to 210° C. Thereafter, while gradually reducing the pressure, the reaction was continued for 6 hours at 230° C. under the reduced pressure of 200 Pa. The number average molecular weight of the obtained polyester resin was 7,000. Then, 180 parts by mass of the synthesized polyester resin was taken and 378 parts by mass of toluene and 42 parts by mass of methyl isobutyl ketone were added thereto, to prepare a polyester solution (PES-1).

1-2. Polyester Polyurethane Resin

Polyester urethane resins a1 to a7 were obtained by the following methods.

(1) Polyester Urethane Resin a1

in a flask equipped with a stirrer, a reflux dehydrator, and a distillation tube, 600 parts by mass of PES-360HVXM30, 100 parts by mass of toluene, and 20 parts by mass of neopentyl glycol were charged. After raising the temperature to 120° C. to distill off 100 parts by mass of the solvent containing water, the temperature was lowered to 105° C., and 0.4 parts by mass of 2,2-dimethylolpropionic acid was charged and dissolved therein. Thereafter, 34 parts by mass of hexamethylene diisocyanate was added and, after 30 minutes, 0.2 parts by mass of dibutyl tin dilaurate was added. After continuing the reaction for 6 hours, a solution of polyester urethane resin a1 was obtained by diluting with toluene/2-propanol to adjust the solid content concentration to 30%. The number average molecular weight of the resin was 36,000 and the acid value was 2 mgKOH/g.

(2) Polyester Urethane Resins a2 to a8

Polyester urethane resins a2 to a1 were each obtained by synthesizing under the same conditions as polyester urethane resin a1, except that the polyester, the diol, and the diisocyanate as the raw materials were changed as shown in Table 1.

TABLE 1

| | | Polyester urethane resin | | | | | | | |
|---|---|---|---|---|---|---|---|---|---|
| | | a1 | a2 | a3 | a4 | a5 | a6 | a7 | a8 |
| Polyester | PES-360HVXM30 | 600 | 600 | 600 | 600 | 600 | — | — | 600 |
| | PES-1 | — | — | — | — | — | 600 | 600 | — |
| Diol component | Neopentyl glycol | 20 | — | — | 133 | — | 65 | — | — |
| | 2-Butyl-2-ethyl-1,3-propanediol | — | 30 | — | — | — | — | — | — |
| | 1,4-Butandiol | — | — | — | — | 17 | — | — | — |
| | 2,2-Dimethylolpropionic acid | 0.4 | 0.4 | 0.5 | 0.5 | 0.4 | 1.4 | 0.4 | 26 |
| Isocyanate component | Hexamethylene diisocyanate | 34 | 34 | 3 | 216 | 34 | 106 | 1.5 | 34 |

| | | | | | | | | |
|---|---|---|---|---|---|---|---|---|
| Glass transition temperature of polyester (° C.) | 65 | 65 | 65 | 65 | 65 | 62 | 62 | 65 |
| Number average molecular weight Mn | 36,000 | 35,000 | 32,000 | 40,000 | 40,000 | 15,000 | 9,000 | 19,000 |
| Molecular weight per urethane bond | 920 | 920 | 10,700 | 160 | 1,030 | 380 | 3,000 | 490 |
| Acid value (mg KOH/g) | 2 | 2 | 2 | 2 | 2 | 3 | 11 | 42 |

The unit of the numerical value in each component column shown in Table 1 is parts by mass.

1-3. Epoxy Resin (B)

The following commercial products were used.

(1) Epoxy Resin b1

Bisphenol A novolak type epoxy resin “EPICLON N-865” (trade name) manufactured by DIC Corporation

(2) Epoxy Resin b2

Bisphenol A type epoxy resin “jER 1055” (trade name) manufactured by Mitsubishi Chemical Corporation

1-4. Polyamide Resin (C)

(1) Polyamide Resin c1

Polyamide resin c1 was synthesized as follows.

In a flask equipped with a stirrer, a reflux dehydrator, and a distillation tube, 65 parts by mass of azelaic acid, 190 parts by mass of dodecanedioic acid, 100 parts by mass of piperazine, and 120 parts by mass of distilled water were charged. After raising the temperature to 120° C. to distill off water, the temperature was raised to 240° C. at a rate of 20° C./hour, and the reaction was continued for 3 hours to obtain polyamide resin ci. The amine value of this resin was 4.5 mgKOH/g.

(2) Polyamide Resin c2

Polyamide resin c2 was synthesized as follows.

In a flask equipped with a stirrer, a reflux dehydrator, and a distillation tube, 485 parts by mass of dimer acid, 100 parts by mass of hexamethylenediamine, and 120 parts by mass of distilled water was charged. After raising the temperature to 120° C. to distill off water, the temperature was raised to 240° C. at a rate of 20° C./hour, and the reaction was continued for 3 hours to obtain polyamide resin c2. The amine value of this resin was 4.5 mgKOH/g.

1-5. Organic Filler (D)

(1) Organic Filler d1

Urethane beads “TK-800T” (trade name; average particle diameter 8 μm) manufactured by Negami Kogyo Co., Ltd.

(2) Organic Filler d2

Acrylic beads “J-4P” (trade name; average particle diameter 2.2 μm) manufactured by Negami Kogyo Co., Ltd.

1-6. Imidazole Silane Compound (E)

1-(2-Hydroxy-3-trimethoxysilylpropoxypropyl)imidazole

1-7. Metal Filler (F)

Copper powder “FCC-115A” (trade name; in particle size distribution, the amount of particles of 45 μm or less is more than 90% by mass, the amount of particles of from 45 μm to 63 μm is less than 10% by mass, and the amount of particles of from 63 μm to 75 μm is less than 3% by mass), manufactured by Fukuda Metal Foil Powder Industry Co., Ltd,

1-8. Flame Retardant

Aluminum dimethylphosphinate “Exolit OP935” (trade name) manufactured by Clariant

1-9. Curing Promoter

Imidazole-based curing promoter “Curesol C11-Z” (trade name) manufactured by Shikoku Kasei Kogyo Co., Ltd.

1-10. Carbon Black

Carbon black “MA-100” (trade name, arithmetic mean particle diameter 24 nm) manufactured by Mitsubishi Chemical Corporation

1-11. Solvent

A mixed solvent consisting of toluene, methyl isobutyl ketone, and 2-propanol (mass ratio=100:20:20)

### Examples 1 to 21 and Comparative Examples 1 to 3

To a flask equipped with a stirrer, the raw materials were added at the ratio shown in Table 2, and stirred under heating at 60° C. for 6 hours to dissolve the component (A), the component (B), the component (C), the component (E) and the curing promoter in the solvent and then disperse the component (D), the component (F), carbon black and the flame retardant, thereby producing the respective liquid resin compositions.

These liquid resin compositions were used to prepare coverlay films, bonding sheets, and adhesion test pieces A and B as follows.

(1) Preparation of Coverlay Film

The liquid resin composition is roll-coated onto the surface of a polyimide film having a thickness of 25 μm so that the thickness after drying was 15 μm, and dried at 120° C. for 2 minutes to obtain a coverlay film that includes a resin composition layer,

(2) Preparation of Adhesive Test Piece A

A gold-plated copper foil with a thickness of 35 μm was prepared. Then, the gold-plated surface was layered so as to be brought into contact with the surface of the resin composition layer of the coverlay film, and laminating was performed under the conditions of 150° C., 0.3 MPa, and 1 m/min. The obtained layered body (polyimide film/resin composition layer/gold-plated copper foil) was subject to thermal compression bonding for 5 minutes under the conditions of 150° C. and 3 MPa, and then further underwent after-cure (post-curing) at 160° C. for 2 hours in an oven, by which an adhesion test piece A was obtained.

(3) Preparation of Bonding Sheet

A releasable PET film with a thickness of 35 μm was prepared. Then, the liquid resin composition was roll-coated onto the surface thereof so that the thickness after drying was 25 μm, and dried at 140° C. for 2 minutes to obtain a bonding sheet that includes a resin composition layer.

(4) Preparation of Adhesion Test Piece B

A nickel-plated SUS (stainless steel) 304 plate with a thickness of 300 μm, and a flexible printed wiring board in which a copper wiring pattern is formed on the surface of a polyimide film with a thickness of 25 μm and a coverlay film with a thickness of 37.5 μm having a through hole with a diameter of 1 mm was layered on the copper wiring pattern, were prepared. First, the nickel-plated surface of the SUS304 plate was layered so as to be brought into contact with the surface of the resin composition layer of the bonding sheet, and laminating was performed under the conditions of 150° C., 0.3 MPa, and 1 m/min to obtain a layered body (SUS plate/resin composition layer/releasable PET film). Then, the releasable PET film was peeled off, and the flexible printed wiring board was bonded to the surface of the exposed resin composition layer by thermal compression bonding for 5 minutes under the conditions of 150° C. and 3 MPa, and then further underwent after-cure at 160° C. for 2 hours in an oven, by which an adhesion test piece B (SUS plate/resin composition layer/flexible printed wiring board) was produced.

These coverlay film, bonding sheet, and adhesion test pieces A and B were prepared and evaluated in accordance with (i) to (vii) below. The results are shown in Table 2.

(i) Peel Adhesion Strength (Adhesive Force)

In order to evaluate the adhesiveness, the 180° peel adhesion strength (N/mm) when the gold-plated copper foil of each adhesion test piece A was peeled off from the polyimide film under the conditions of the temperature of 23° C. and the tensile speed of 50 min/min in accordance with JIS C 6481 (1996) “Test methods of copper-clad laminates for printed. wiring boards” was measured. The width of the adhesion test piece during the measurement was 10 mm.

(ii) Solder Heat Resistance (Appearance at the Time of Soldering)

The test was conducted under the following conditions in accordance with JIS C 6481 (1996).

The adhesion test piece A was floated in a solder bath at 260° C. for 60 seconds with the surface of the polyimide film up, and the presence or absence of appearance abnormalities such as swelling or peeling of the adhesive layer was visually evaluated. As a result, those in which appearance abnormalities such as microvoids, swelling, or peeling were not confirmed were indicated as “A”, those in which slight microvoids were observed were indicated as “B”, and those in which appearance abnormalities such as swelling and peeling were confirmed were indicated as “C”.

Further, the test piece taken out from the solder bath was measured in terms of 180° peel adhesion strength (N/cm) when the gold-plated copper foil was peeled off from the polyimide film at 23° C. in accordance with HS C 6481 (1996). The width of the adhesion test piece during the measurement was 10 mm, and the tensile speed was 50 min/min,

(iii) Flame Retardancy

The coverlay film was heat-cured at 160° C. for 2 hours, and the flame retardancy was evaluated in accordance with UL-94. Those that passed the test (VTM-0 class) were indicated as “A”, and those that failed were indicated as “F”.

(iv) Conductivity (Connection Resistance)

The connection resistance value between the SUS plate and the copper foil wiring of the flexible printed wiring board of the adhesion test piece B (SUS plate/resin composition layer/flexible printed wiring board) was measured with a resistance value measuring instrument. As a result, those in which the connection resistance value was less than 0.5Ω were indicated as “A”, those in which the connection resistance value was 0.5Ω or more but less than 1Ω were indicated as “B”, those in which the connection resistance value was 1Ω or more but 3Ω or less were indicated as “C”, and those in which the connection resistance value was more than 3Ω were indicated as “D”.

(v) Conductivity (Connection Resistance) After Soldering

The adhesion test piece B was floated in a solder bath at 260° C. for 60 seconds. Thereafter, the connection resistance value between the SUS plate and the copper foil wiring of the flexible printed wiring board of the adhesion test piece B taken out from the solder bath was measured with a resistance value measuring instrument. As a result, those in which the connection resistance value was less than 0.5Ω were indicated as “A”, those in which the connection resistance value was 0.5Ω or more but less than 1Ω were indicated as “B”, those in which the connection resistance value was 1Ω or more but 3Ω or less were indicated as “C”, and those in which the connection resistance value was more than 3Ω were indicated as “D”.

(vi) Conductivity (Connection Resistance) After Long-Term Reliability Test

The adhesion test piece B was left in a constant temperature and humidity chamber at 85° C. and 85% RH for 1,000 hours. Thereafter, the connection resistance value between the SUS plate and the copper foil wiring of the flexible printed wiring board of the adhesion test piece B was measured with a resistance value measuring instrument. As a result, those in which the connection resistance value was less than 0.5Ω were indicated as “A”, those in which the connection resistance value was 0.5Ω or more but less than 1Ω were indicated as “B”, those in which the connection resistance value was 1Ω or more but 3Ω or less were indicated as “C”, and those in which the connection resistance value was more than 3Ω were indicated as “D”.

(viii) Storage Stability of Resin Composition

Each of the resin compositions of Examples 1 to 20 and Comparative Examples 1 to 3 having the compositions shown in Table 2 was put in a glass bottle, sealed, stored at 5° C. for a predetermined period, and observed in terms of crystallinity of the composition. Those in which gelation of the resin composition or liquid separation was confirmed after storage for the predetermined period were regarded as poor in storage stability and evaluated. Even a resin composition that is evaluated as F can be used without any problem by using it immediately after preparation or by avoiding a long-term storage at low temperature.

<Evaluation Criteria>

A: Gelation or liquid separation was not confirmed even after storage for 1 week.

F: At least one of gelation or liquid separation was confirmed after storage for less than 1 week.

TABLE 2

| | | | Examples | | | | | | | |
|---|---|---|---|---|---|---|---|---|---|---|
| | | | 1 | 2 | 3 | 4 | 5 | 6 | 7 | 8 |
| Composition | Polyester | a1 | 50 | 82 | 8 | 50 | 50 | 50 | 50 | 50 |
| of resin | polyurethane | a2 | — | — | — | — | — | — | — | — |
| composition | resin (A) | a3 | — | — | — | — | — | — | — | — |
| | | a4 | — | — | — | — | — | — | — | — |
| | | a5 | — | — | — | — | — | — | — | — |
| | | a6 | — | — | — | — | — | — | — | — |
| | | a7 | — | — | — | — | — | — | — | — |
| | | a8 | — | — | — | — | — | — | — | — |
| | Epoxy | b1 | 5 | 5 | 5 | 5 | 5 | 5 | 5 | 5 |
| | resin (B) | b2 | 5 | 5 | 5 | 5 | 5 | 5 | 5 | 5 |
| | Polyamide | c1 | 40 | 8 | 82 | 40 | 40 | 40 | 40 | 40 |
| | resin (C) | c2 | — | — | — | — | — | — | — | — |
| | Organic | d1 | — | — | — | 15 | — | 45 | 5 | 15 |
| | filler (D) | d2 | — | — | — | — | 15 | — | — | — |
| | Imidazole silane compound (E) | | 3 | 3 | 3 | 3 | 3 | 3 | 3 | — |
| | Metal filler (F) | | 20 | 20 | 20 | 20 | 20 | 20 | 20 | 20 |
| | Carbon black | | — | — | — | — | — | — | — | — |
| | Curing promoter | | 1 | 1 | 1 | 1 | 1 | 1 | 1 | 1 |
| | Flame retardant | | 5 | 5 | 5 | 5 | 5 | 5 | 5 | 5 |
| | Solvent (mixed solvent) | | 200 | 200 | 200 | 200 | 200 | 200 | 200 | 200 |
| Evaluation | Peel adhesion | Initial | 6 | 5 | 10 | 6 | 6 | 4 | 6 | 4 |
| result | strength (N/mm) | After soldering | 8 | 7 | 12 | 8 | 8 | 5 | 8 | 6 |
| | Appearance at the time of | | A | B | A | A | A | A | A | A |
| | soldering (heat resistance) | | | | | | | | | |
| | Flame retardancy | | A | A | A | A | A | A | A | A |
| | Conductivity | Initial | B | B | B | A | A | A | B | C |
| | | After soldering | B | C | B | A | A | B | B | C |
| | | After storage at 85° C., | B | C | C | A | B | B | B | C |
| | | 85% RH, for 1,000 hrs | | | | | | | | |
| | Storage stability | | A | A | A | A | A | A | A | A |
| | | | Examples | | | | | | | |
| | | | 9 | 10 | 11 | 12 | 13 | 14 | 15 | 16 |
| Composition | Polyester | a1 | 50 | 50 | — | — | — | — | — | — |
| of resin | polyurethane | a2 | — | — | 50 | — | — | — | — | — |
| composition | resin (A) | a3 | — | — | — | 50 | — | — | — | — |
| | | a4 | — | — | — | — | 50 | — | — | — |
| | | a5 | — | — | — | — | — | 50 | — | — |
| | | a6 | — | — | — | — | — | — | 50 | — |
| | | a7 | — | — | — | — | — | — | — | 50 |
| | | a8 | — | — | — | — | — | — | — | — |
| | Epoxy | b1 | — | 5 | 5 | 5 | 5 | 5 | 5 | 5 |
| | resin (B) | b2 | 10 | 5 | 5 | 5 | 5 | 5 | 5 | 5 |
| | Polyamide | c1 | 40 | 40 | 40 | 40 | 40 | 40 | 40 | 40 |
| | resin (C) | c2 | — | — | — | — | — | — | — | — |
| | Organic | d1 | 15 | 15 | 15 | 15 | 15 | 15 | 15 | 15 |
| | filler (D) | d2 | — | — | — | — | — | — | — | — |
| | Imidazole silane compound (E) | | 3 | 15 | 3 | 3 | 3 | 3 | 3 | 3 |
| | Metal filler (F) | | 20 | 20 | 20 | 20 | 20 | 20 | 20 | 20 |
| | Carbon black | | — | — | — | — | — | — | — | — |
| | Curing promoter | | 1 | 1 | 1 | 1 | 1 | 1 | 1 | 1 |
| | Flame retardant | | 5 | 5 | 5 | 5 | 5 | 5 | 5 | 5 |
| | Solvent (mixed solvent) | | 200 | 200 | 200 | 200 | 200 | 200 | 200 | 200 |
| Evaluation | Peel adhesion | Initial | 6 | 6 | 6 | 5 | 7 | 5 | 6 | 6 |
| result | strength (N/mm) | After soldering | 8 | 8 | 8 | 7 | 9 | 7 | 8 | 8 |
| | Appearance at the time of | | A | A | A | B | A | A | B | B |
| | soldering (heat resistance) | | | | | | | | | |
| | Flame retardancy | | A | A | A | A | A | A | A | A |
| | Conductivity | Initial | B | A | A | C | A | B | C | C |
| | | After soldering | B | A | A | C | A | B | C | C |
| | | After storage at 85° C., | B | A | A | C | C | B | C | C |
| | | 85% RH, for 1,000 hrs | | | | | | | | |
| | Storage stability | | A | F | A | A | F | F | A | A |
| | | | | | | | | Comparative | | |
| | | | Examples | | | | | Examples | | |
| | | | 17 | 18 | 19 | 20 | 21 | 1 | 2 | 3 |
| Composition | Polyester | a1 | — | 50 | 50 | 50 | 50 | 90 | — | 50 |
| of resin | polyurethane | a2 | — | — | — | — | — | — | — | — |
| composition | resin (A) | a3 | — | — | — | — | — | — | — | — |
| | | a4 | — | — | — | — | — | — | — | — |
| | | a5 | — | — | — | — | — | — | — | — |
| | | a6 | — | — | — | — | — | — | — | — |
| | | a7 | — | — | — | — | — | — | — | — |
| | | a8 | 50 | — | — | — | — | — | — | — |
| | Epoxy | b1 | 5 | 5 | 5 | 5 | 5 | 5 | 5 | — |
| | resin (B) | b2 | 5 | 5 | 5 | 5 | 5 | 5 | 5 | — |
| | Polyamide | c1 | 40 | 40 | 40 | — | — | — | 90 | 40 |
| | resin (C) | c2 | — | — | — | 40 | 40 | — | — | — |
| | Organic | d1 | 15 | — | — | 15 | 15 | 10 | 10 | 10 |
| | filler (D) | d2 | — | — | — | — | — | — | — | — |
| | Imidazole silane compound (E) | | 3 | 3 | 3 | — | — | 3 | 3 | 3 |
| | Metal filler (F) | | 20 | 9 | 360 | 20 | 20 | 20 | 20 | 20 |
| | Carbon black | | — | — | — | — | 5 | — | — | — |
| | Curing promoter | | 1 | 1 | 1 | 1 | 1 | 1 | 1 | 1 |
| | Flame retardant | | 5 | 5 | 5 | 5 | 5 | 5 | 5 | 5 |
| | Solvent (mixed solvent) | | 200 | 200 | 200 | 200 | 200 | 200 | 200 | 200 |
| Evaluation | Peel adhesion | Initial | 6 | 6 | 3 | 4 | 6 | 2 | 12 | 4 |
| result | strength (N/mm) | After soldering | 8 | 8 | 5 | 6 | 8 | 3 | 15 | 5 |
| | Appearance at the time of | | B | A | B | B | A | C | A | C |
| | soldering (heat resistance) | | | | | | | | | |
| | Flame retardancy | | A | A | A | A | A | A | A | A |
| | Conductivity | Initial | B | C | B | C | B | D | B | D |
| | | After soldering | B | C | B | C | B | D | B | D |
| | | After storage at 85° C., | B | C | B | C | B | D | D | D |
| | | 85% RH, for 1,000 hrs | | | | | | | | |

| | | | | | | | | |
|---|---|---|---|---|---|---|---|---|
| Storage stability | F | A | F | A | A | A | A | A |

The unit of the numerical value of each component column in composition of the resin composition shown in Table 2 is parts by mass.

As is clear from the results shown in Table 2, the resin compositions of Examples 1 to 21 were superior in conductivity compared to the resin compositions of Comparative Examples 1 to 3, even after the long-term storage under environment of high temperature and high humidity.

Further, Comparative Example 2, which did not contain the polyester polyurethane resin (A), was poor in moist heat resistance. Comparative Example 3, which did not contain the epoxy resin (B), was poor in solder heat resistance and conductivity. Comparative Example 1, which did not contain the polyimide resin (C), was poor particularly in peel strength and was also poor in solder heat resistance and conductivity.

Further, compared to Example 3, in which the content of the polyester polyurethane resin (A) was 8% by mass, Example 1 or the like, in which the content thereof was 10% by mass or more, was superior in moist heat resistance. Compared to Example 2, in which the content of the polyester polyurethane resin (A) was 82% by mass, Example 1 or the like, in which the content thereof was 70% by mass or less, was superior in peel strength and solder heat resistance

Further, compared to Examples 1 to 3, which did not contain the organic filler (D), or Example 7, in which the content thereof was less than 5 parts by mass, Example 4 or the like, in which the content of the organic filler (D) was 5 parts by mass or more, was superior in moist heat resistance and conductivity. Compared to Example 6, in which the content of the organic filler (D) was 45 parts by mass, Example 4 or the like, in which the content thereof was 40 parts by mass or less, was superior in peel strength. In particular, the addition of the urethane filler resulted in better affinity with the resin, and superior conductivity and liquid stability.

Further, compared to Example 8, which did not contain the imidazole silane compound (E), Example 1 or the like, in which the content thereof was 0.1% by mass or more, was superior in peel strength, moist heat resistance, or conductivity. Compared to Example 10, in which the content of the imidazole silane compound (E) was 15% by mass, Example 1 or the like, in which the content thereof was 10% by mass or less, was superior in liquid stability.

Compared to Example 9, in which only the bisphenol A type epoxy resin was formulated as the epoxy resin (B), Example 1 or the like, which contained both the bisphenol A type epoxy resin and the novolac type epoxy resin, was superior in conductivity.

Compared to Example 16, which used a7 having a number average molecular weight of 9,000 as the polyester polyurethane resin (A), Example 1 or the like, which used a polyester polyurethane resin (A) having a number average molecular weight of 10,000 or more, was superior in solder heat resistance and moist heat resistance.

Further, compared to Example 13, which used a4 having a molecular weight per urethane bond in the polyester polyurethane resin (A) of 160, Example 1 or the like, which used one having a molecular weight per urethane bond of from 200 to 8,000, was superior in liquid stability and moist heat resistance. Compared to Example 12, which used a3 having a molecular weight per urethane bond of 10,700, Example 1 or the like was superior in peel strength, solder heat resistance, and conductivity.

The use of a polyester polyurethane with lower acid value resulted in superior solder heat resistance to the use of a polyester polyurethane with higher acid value.

Further, compared to Example 18, in which the content of the metal filler (F) was 9 parts by mass, Example 1 or the like, in which the content of the metal filler was from 10 parts by mass to 350 parts by mass, was superior in conductivity.

Compared to Example 19, in which the content of the metal filler (F) was 360 parts by mass, Example 1 or the like, in which the content of the metal filler was from 10 parts by mass to 350 parts by mass, was superior in liquid stability.

The disclosure of Japanese Patent Application No. 2019-085255, filed Apr. 26, 2019, is incorporated herein by reference in its entirety.

All publications, patent applications, and technical standards described in present specification are herein incorporated by reference to the same extent as if each individual publication, patent application, or technical standard was specifically and individually indicated to be incorporated by reference.

1. A resin composition, comprising:
a polyester polyurethane resin (A);
an epoxy resin (B); and
a polyamide resin (C).

2. The resin composition according to claim 1, wherein a content of the polyester polyurethane resin (A) is from 10% by mass to 70% by mass, and a content of the polyamide resin (C) is from 10% by mass to 70% by mass, each with respect to a total amount of the polyester polyurethane resin (A), the epoxy resin (B), the polyamide resin (C), and an imidazole silane compound (E) that may be included as an optional component in the resin composition.

3. The resin composition according to claim 1, further comprising an organic filler (D).

4. The resin composition according to claim 3, wherein a content of the organic filler (D) is from 5 parts by mass to 40 parts by mass with respect to the total amount, of 100 parts by mass, of the polyester polyurethane resin (A), the epoxy resin (B), the polyamide resin (C), and the imidazole silane compound (E) that may be included as an optional component in the resin composition.

5. The resin composition according to claim 1, further comprising the imidazole silane compound (E).

6. The resin composition according to claim 5, wherein a content of the imidazole silane compound (E) is from 0.1% by mass to 10% by mass with respect to the total amount of the polyester polyurethane resin (A), the epoxy resin (B), the polyamide resin (C), and the imidazole silane compound (E) in the resin composition.

7. The resin composition according to claim 1, wherein the epoxy resin (B) comprises at least one of a bisphenol A type epoxy resin or a novolak type epoxy resin.

8. The resin composition according to claim 1, wherein a number average molecular weight of the polyester polyurethane resin (A) is from 10,000 to 80,000, and a molecular weight per urethane bond in the polyester polyurethane resin (A) is 200 to 8,000.

9. The resin composition according to claim 1, wherein an acid value of the polyester polyurethane resin (A) is from 0.1 mgKOH/g to 20 mgKOH/g.

10. The resin composition according to claim 1, wherein a diol component configuring the polyester polyurethane resin (A) comprises a diol having a side chain.

11. The resin composition according to claim 1, wherein the polyester polyurethane resin (A) comprises a polyester polyurethane resin having a polyester structure that has a number average molecular weight of from 8,000 to 30,000.

12. The resin composition according to claim 1, comprising, when a total amount of a diamine component configuring the polyamide resin (C) is 100 mol %, 20 mol % or more of piperazine as the diamine component.

13. The resin composition according to claim 1, further comprising a metal filler (F).

14. The resin composition according to claim 13, wherein a content of the metal filler (F) is from 10 parts by mass to 350 parts by mass with respect to the total amount of 100 parts by mass of the polyester polyurethane resin (A), the epoxy resin (B), the polyamide resin (C), and the imidazole silane compound (E) that may be included as an optional component in the resin composition.

15. The resin composition according to claim 13, wherein the metal filler (F) is a conductive filler.

16. A bonding film, comprising:
a resin composition layer that consists of the resin composition according to claim 1; and
a release film that is in contact with at least one surface of the resin composition layer,
wherein the resin composition layer is in a B-stage state.

17. A layered body including a resin composition layer, the layered body comprising:
a resin composition layer that consists of the resin composition according to claim 1; and
a base film that is in contact with at least one surface of the resin composition layer,
wherein the resin composition layer is in a B-stage state.

18. A layered body, comprising a cured layer obtained by curing the resin composition according to claim 1.

19. An electromagnetic wave shielding film, comprising a resin composition layer that consists of the resin composition according to claim 1.
